(19) United States
(12) Patent Application Publication
(10) Pub. No.: US 2022/0245842 A1
(43) Pub. Date: Aug. 4, 2022

(54) SYSTEM AND METHOD FOR OBJECT RECOGNITION USING FLUORESCENT AND ANTIREFLECTIVE SURFACE CONSTRUCTS

(71) Applicant: BASF COATINGS GMBH, Münster (DE)

(72) Inventors: Yunus Emre Kurtoglu, Southfield, MI (US); Matthew Ian Childers, Southfield, MI (US)

(21) Appl. No.: 17/617,132

(22) PCT Filed: Jun. 5, 2020
(86) PCT No.: PCT/EP2020/065750

§ 371 Date: Dec. 7, 2021

Related U.S. Application Data
(60) Provisional application No. 62/858,358, filed on Jun. 7, 2019.

(30) Foreign Application Priority Data
Jun. 7, 2019 (EP) 19179184.7

(51) Int. Cl. G06T 7/521; G06V 10/74; G02B 5/30

(52) U.S. Cl. CPC G06T 7/521; G02B 5/3083; G06V 10/74

(57) ABSTRACT

Described herein are a system and a method for object recognition via a computer vision application, the system including at least the following components:
at least one object to be recognized, the object having object specific reflectance and luminescence spectral patterns,
a light source which is configured to illuminate a scene including the at least one object under ambient lighting conditions,
a sensor which is configured to measure radiance data of the scene including the at least one object when the scene is illuminated by the light source,
a linear polarizer coupled with a quarter waveplate,
a data storage unit which comprises luminescence spectral patterns together with appropriately assigned respective objects, and
a data processing unit.

The present disclosure refers to a system and method for object recognition using fluorescent and antireflective surface constructs.

### BACKGROUND

Computer vision is a field in rapid development due to abundant use of electronic devices capable of collecting information about their surroundings via 15 sensors such as cameras, distance sensors such as LiDAR or radar, and depth camera systems based on structured light or stereo vision to name a few. These electronic devices provide raw image data to be processed by a computer processing unit and consequently develop an understanding of an environment or a scene using artificial intelligence and/or computer assistance 20 algorithms. There are multiple ways how this understanding of the environment can be developed. In general, 2D or 3D images and/or maps are formed, and these images and/or maps are analyzed for developing an understanding of the scene and the objects in that scene. One prospect for improving computer vision is to measure the components of the chemical makeup of objects in the 25 scene. While shape and appearance of objects in the environment acquired as 2D or 3D images can be used to develop an understanding of the environment, these techniques have some shortcomings.

One challenge in computer vision field is being able to identify as many objects 30 as possible within each scene with high accuracy and low latency using a minimum amount of resources in sensors, computing capacity, light probe etc. The object identification process has been termed remote sensing, object identification, classification, authentication or recognition over the years. In the scope of the present disclosure, the capability of a computer vision system to identify an object in a scene is termed as “object recognition”. For example, a computer analyzing a picture and identifying/labelling a ball in that picture, sometimes with even further information such as the type of a ball (basketball, soccer ball, baseball), brand, the context, etc. fall under the term “object recognition”.

Generally, techniques utilized for recognition of an object in computer vision systems can be classified as follows:

Technique 1: Physical tags (image based): Barcodes, QR codes, serial numbers, text, patterns, holograms etc.

Technique 2: Physical tags (scan/close contact based): Viewing angle dependent pigments, upconversion pigments, metachromics, colors (red/green), luminescent materials.

Technique 3: Electronic tags (passive): RFID tags, etc. Devices attached to objects of interest without power, not necessarily visible but can operate at other frequencies (radio for example).

Technique 4: Electronic tags (active): wireless communications, light, radio, vehicle to vehicle, vehicle to anything (X), etc. Powered devices on objects of interest that emit information in various forms.

Technique 5: Feature detection (image based): Image analysis and identification, i.e. two wheels at certain distance for a car from side view; two eyes, a nose and mouth (in that order) for face recognition etc. This relies on known geometries/shapes.

Technique 6: Deep learning/CNN based (image based): Training of a computer with many of pictures of labeled images of cars, faces etc. and the computer determining the features to detect and predicting if the objects of interest are present in new areas. Repeating of the training procedure for each class of object to be identified is required.

Technique 7: Object tracking methods: Organizing items in a scene in a particular order and labeling the ordered objects at the beginning. Thereafter following the object in the scene with known color/geometry/3D coordinates. If the object leaves the scene and re-enters, the “recognition” is lost.

In the following, some shortcomings of the above-mentioned techniques are presented.

Technique 1: When an object in the image is occluded or only a small portion of the object is in the view, the barcodes, logos etc. may not be readable. Furthermore, the barcodes etc. on flexible items may be distorted, limiting visibility. All sides of an object would have to carry large barcodes to be visible from a distance otherwise the object can only be recognized in close range and with the right orientation only. This could be a problem for example when a barcode on an object on the shelf at a store is to be scanned. When operating over a whole scene, technique 1 relies on ambient lighting that may vary.

Technique 2: Upconversion pigments have limitations in viewing distances because of the low level of emitted light due to their small quantum yields. They require strong light probes. They are usually opaque and large particles limiting options for coatings. Further complicating their use is the fact that compared to fluorescence and light reflection, the upconversion response is slower. While some applications take advantage of this unique response time depending on the compound used, this is only possible when the time of flight distance for that sensor/object system is known in advance. This is rarely the case in computer vision applications. For these reasons, anti-counterfeiting sensors have covered/dark sections for reading, class 1 or 2 lasers as probes and a fixed and limited distance to the object of interest for accuracy.

Similarly viewing angle dependent pigment systems only work in close range and require viewing at multiple angles. Also, the color is not uniform for visually pleasant effects. The spectrum of incident light must be managed to get correct measurements. Within a single image/scene, an object that has angle dependent color coating will have multiple colors visible to the camera along the sample dimensions.

Color-based recognitions are difficult because the measured color depends partly on the ambient lighting conditions. Therefore, there is a need for reference samples and/or controlled lighting conditions for each scene. Different sensors will also have different capabilities to distinguish different colors, and will differ from one sensor type/maker to another, necessitating calibration files for each sensor.

Luminescence based recognition under ambient lighting is a challenging task, as the reflective and luminescent components of the object are added together. Typically luminescence based recognition will instead utilize a dark measurement condition and a priori knowledge of the excitation region of the luminescent material so the correct light probe/source can be used.

Technique 3: Electronic tags such as RFID tags require the attachment of a circuit, power collector, and antenna to the item/object of interest, adding cost and complication to the design. RFID tags provide present or not type information but not precise location information unless many sensors over the scene are used.

Technique 4: These active methods require the object of interest to be connected to a power source, which is cost-prohibitive for simple items like a soccer ball, a shirt, or a box of pasta and are therefore not practical.

Technique 5: The prediction accuracy depends largely on the quality of the image and the position of the camera within the scene, as occlusions, different viewing angles, and the like can easily change the results. Logo type images can be present in multiple places within the scene (i.e., a logo can be on a ball, a T-shirt, a hat, or a coffee mug) and the object recognition is by inference. The visual parameters of the object must be converted to mathematical parameters at great effort. Flexible objects that can change their shape are problematic as each possible shape must be included in the database. There is always inherent ambiguity as similarly shaped objects may be misidentified as the object of interest.

Technique 6: The quality of the training data set determines the success of the method. For each object to be recognized/classified many training images are needed. The same occlusion and flexible object shape limitations as for Technique 5 apply. There is a need to train each class of material with thousands or more of images.

Technique 7: This technique works when the scene is pre-organized, but this is rarely practical. If the object of interest leaves the scene or is completely occluded the object could not be recognized unless combined with other techniques above.

Apart from the above-mentioned shortcomings of the already existing techniques, there are some other challenges worth mentioning. The ability to see a long distance, the ability to see small objects or the ability to see objects with enough detail all require high resolution imaging systems, i.e. high-resolution camera, LiDAR, radar etc. The high-resolution needs increase the associated sensor costs and increase the amount of data to be processed.

For applications that require instant responses like autonomous driving or security, the latency is another important aspect. The amount of data that needs to be processed determines if edge or cloud computing is appropriate for the application, the latter being only possible if data loads are small. When edge computing is used with heavy processing, the devices operating the systems get bulkier and limit ease of use and therefore implementation.

Thus, a need exists for systems and methods that are suitable for improving object recognition capabilities for computer vision applications.

### SUMMARY OF THE INVENTION

The present disclosure provides a system and a method with the features of the independent claims. Embodiments are subject of the dependent claims and the description and drawings.

According to claim 1, a system for object recognition via a computer vision application is provided, the system comprising at least the following components:
at least one object to be recognized, the object having object specific reflectance and luminescence spectral patterns,
a light source which is configured to illuminate a scene which includes the at least one object, preferably under ambient lighting conditions,
a sensor which is configured to measure radiance data of the scene including the at least one object when the scene is illuminated by the light source,
a linear polarizer coupled with a quarter waveplate, the quarter waveplate being oriented with its fast and slow axes at an angle in the range of 40 to 50 degrees, preferably of 42 to 48 degrees, more preferably of 44 to 46 degrees relative to the linear polarizer, the linear polarizer and the quarter waveplate being positioned between the light source and the at least one object and between the sensor and the at least one object,
a data storage unit which comprises luminescence spectral patterns together with appropriately assigned respective objects,
a data processing unit which is configured to extract/detect the object specific luminescence spectral pattern of the at least one object to be recognized out of the measured radiance data of the scene and to match the extracted/detected object specific luminescence spectral pattern with the luminescence spectral patterns stored in the data storage unit, and to identify a best matching luminescence spectral pattern and, thus, its assigned object.

Technically the construct of linear polarizer and quarter waveplate needs to be between the light source and the object AND between the object and the sensor, i.e. the light must travel through the linear polarizer on the way to the object and then travel through it again on its way to the sensor.

In one aspect of the proposed system, the linear polarizer and the quarter waveplate are fused together forming one optical component. The linear polarizer and the quarter waveplate are applied directly on top of the at least one object, preferably as a coating or wrap, to form a 3-layer construct. Preferably, the at least one object has an essentially flat surface to which the linear polarizer and the quarter waveplate as one optical component can be applied.

Within the scope of the present disclosure the terms “fluorescent” and “luminescent” and the terms “fluorescence” and “luminescence” are used synonymously. Within the scope of the present disclosure, the terms “data processing unit”, “processor”, “computer” and “data processor” are to be interpreted broadly and are used synonymously.

In another aspect, embodiments of the invention are directed to a system for object recognition via a computer vision application, the system comprising at least the following components:
at least one object to be recognized, the object being at least semi-transparent and having object specific transmission and luminescence spectral patterns,
a light source which is configured to illuminate a scene which includes the at least one object, preferably under ambient lighting conditions,
two linear polarizers which are aligned at about 0 degrees relative to each other or rotated at about 90 degrees to each other and which are sandwiching the at least one object between them,
a sensor which is configured to measure radiance data of the scene including the at least one object when the scene is illuminated by the light source,
a data storage unit which comprises luminescence spectral patterns together with appropriately assigned respective objects,
a data processing unit which is configured to extract/detect the object specific luminescence spectral pattern of the at least one object to be recognized out of the measured radiance data of the scene and to match the extracted/detected object specific luminescence spectral pattern with the luminescence spectral patterns stored in the data storage unit, and to identify a best matching luminescence spectral pattern and, thus, its assigned object.

According to one embodiment of the proposed system the linear polarizers are applied directly on either side of the at least one object.

In one aspect, each of the two linear polarizers is coupled with a quarter waveplate (lambda quarter plate). In this case the linear polarizers need to be aligned at about 0 degrees relative to each other, i. e. at an angle in the range of −5 to 5 degrees, preferably of −3 to 2 degrees, more preferably of −1 to 1 degrees relative to each other. Each of the quarter waveplates is oriented with its fast and slow axes at about 45 degrees relative to the respective linear polarizer, i. e. at an angle in the range of 40 to 50 degrees, preferably of 42 to 48 degrees, more preferably of 44 to 46 degrees, and each quarter waveplate being oriented at about 0 degrees relative to the other quarter waveplate, i. e. at an angle in the range of −5 to 5 degrees, preferably of −3 to 2 degrees, more preferably of −1 to 1 degrees relative to the other quarter waveplate.

Generally, there are two different alternatives for an arrangement with two linear polarizers, the linear polarizers may be crossed (being oriented at about 90 degrees) relative to each other or aligned (being oriented at about 0 degrees) relative to each other.

In another aspect of the proposed system, the two linear polarizers and the respective two quarter waveplates each coupled with one of the two linear polarizers are applied directly, preferably as respective coating or wrap, on either side of the at least one object, thus forming a 5-layer construct with each layer directly on top of the other. Preferably, the at least one object has two essentially flat surfaces on two opposite sides, to each of which a linear polarizer and a quarter waveplate can be applied as one component to form a 5-layer construct in total.

In a further aspect, the sensor is a hyperspectral camera or a multispectral camera. The sensor is generally an optical sensor with photon counting capabilities. More specifically, it may be a monochrome camera, or an RGB camera, or a multispectral camera, or a hyperspectral camera. The sensor may be a combination of any of the above, or the combination of any of the above with a tuneable or selectable filter set, such as, for example, a monochrome sensor with specific filters. The sensor may measure a single pixel of the scene, or measure many pixels at once. The optical sensor may be configured to count photons in a specific range of spectrum, particularly in more than three bands. It may be a camera with multiple pixels for a large field of view, particularly simultaneously reading all bands or different bands at different times.

A multispectral camera captures image data within specific wavelength ranges across the electromagnetic spectrum. The wavelengths may be separated by filters or by the use of instruments that are sensitive to particular wavelengths, including light from frequencies beyond the visible light range, i.e. infrared and ultra-violet. Spectral imaging can allow extraction of additional information the human eye fails to capture with its receptors for red, green and blue. A multispectral camera measures light in a small number (typically 3 to 15) of spectral bands. A hyperspectral camera is a special case of spectral camera where often hundreds of contiguous spectral bands are available.

The light source may be a switchable light source with two illuminants each comprised of one or more LEDs and with a short switchover time between the two illuminants. The light source is preferably chosen as being capable of switching between at least two different illuminants. Three or more illuminants may be required for some methods. The total combination of illuminants is referred to as the light source. One method of doing this is to create illuminants from different wavelength light emitting diodes (LEDs). LEDs may be rapidly switched on and off, allowing for fast switching between illuminants. Fluorescent light sources with different emissions may also be used. Incandescent light sources with different filters may also be used. The light source may be switched between illuminants at a rate that is not visible to the human eye. Sinusoidal like illuminants may also be created with LEDs or other light sources, which is useful for some of the proposed computer vision algorithms.

The present disclosure describes surface constructs that provide a way of limiting light reflectance from surfaces while simultaneously providing light emissions via luminescence. By incorporating a luminescent material (the object to be recognized) underneath an anti-reflective film structure (linear polarizer(s) coupled with (or without) quarter waveplates), the construct provides a chroma radiating from the material/object independent of the illumination spectral distribution if the electromagnetic radiation of the excitation wavelength is present. Such a system can be constructed by using quarter lambda plate-based polarization anti-reflective constructs with or without a highly specular reflective layer underneath the luminescent layer/material. Such a construct eliminates the ambient light dependency for color space-based recognition techniques for computer vision applications since the chroma observed by the sensor will be independent on the ambient light conditions but only dependent on the chemistry of the luminescent layer (of the object to be recognized). By decoupling the reflectance and luminescence of a surface construct as described, it is possible to use the chroma of luminescence for chemistry-based object recognition since the luminescence is an intrinsic property of the chemical moieties present in the luminescent material/object.

In another aspect, the invention refers to a method for object recognition via a computer vision application, the method comprising at least the following steps:
providing at least one object to be recognized, the object having object specific reflectance and luminescence spectral patterns,
illuminating a scene which includes the at least one object under ambient lighting conditions using a light source,
providing a linear polarizer coupled with a quarter waveplate, the quarter waveplate being oriented with its fast and slow axes at about 45 degrees relative to the linear polarizer, i. e. at an angle in the range of 40 to 50 degrees, preferably of 42 to 48 degrees, more preferably of 44 to 46 degrees relative to the linear polarizer, and
positioning the linear polarizer and the quarter waveplate between the light source and the at least one object and between a sensor and the at least one object,
measuring, using the sensor, radiance data of the scene including the at least one object,
providing a data storage unit which comprises luminescence spectral patterns together with appropriately assigned respective objects,
extracting/detecting the object specific luminescence spectral pattern of the at least one object to be recognized out of the measured radiance data of the scene,
matching the extracted/detected object specific luminescence spectral pattern with the luminescence spectral patterns stored in the data storage unit, and
identifying a best matching luminescence spectral pattern and, thus, its assigned object.

In one aspect, the linear polarizer and the quarter waveplate are applied directly on top of the at least one object to form a 3-layer construct.

In another aspect, embodiments of the invention are directed to a method for object recognition via a computer vision application, the method comprising at least the following steps:
providing at least one object to be recognized, the object being at least semi-transparent and having object specific transmission and luminescence spectral patterns,
illuminating, using a light source, a scene which includes the at least one object under ambient lighting conditions,
providing two linear polarizers which are aligned at about 0 degrees relative to each other or rotated at about 90 degrees to each other and which are sandwiching the at least one object between them,
measuring, using a sensor, radiance data of the scene including the at least one object,
providing a data storage unit which comprises luminescence spectral patterns together with appropriately assigned respective objects,
providing a data processing unit which is programmed to extract/detect the object specific luminescence spectral pattern of the at least one object to be recognized out of the measured radiance data of the scene and to match the extracted/detected object specific luminescence spectral pattern with the luminescence spectral patterns stored in the data storage unit, and to identify a best matching luminescence spectral pattern and, thus, its assigned object.

The linear polarizers may be applied directly on either side of the at least one object

Each of the two linear polarizers may be coupled with a quarter waveplate. In this case the two linear polarizers need to be aligned relative to each other and each quarter waveplate needs to be rotated at about 45 degrees relative to the respective linear polarizers while the quarter waveplates are aligned relative to each other.

The wording “to be aligned” means to be aligned at about 0 degrees relative to each other, i. e. at an angle in the range of −5 to 5 degrees, preferably of −3 to 2 degrees, more preferably of −1 to 1 degrees relative to each other.

According to one possible embodiment of the proposed method, the two linear polarizers and the respective two quarter waveplates each coupled with one of the two linear polarizers are applied directly on either side of the at least one object, thus forming a 5-layer construct with each layer directly on top of the other.

Embodiments of the invention may be used with or incorporated in a computer system that may be a standalone unit or include one or more remote terminals or devices in communication with a central computer, located, for example, in a cloud, via a network such as, for example, the Internet or an intranet. As such, the data processing unit described herein and related components may be a portion of a local computer system or a remote computer or an online system or a combination thereof. The database, i.e. the data storage unit and software described herein may be stored in computer internal memory or in a non-transitory computer readable medium. Within the scope of the present disclosure the database may be part of the data storage unit or may represent the data storage unit itself. The terms “database” and “data storage unit” are used synonymously.

Some or all technical components of the proposed system, namely the light source, the sensor, the linear polarizer(s), the data storage unit and the data processing unit may be in communicative connection with each other. A communicative connection between any of the components may be a wired or a wireless connection. Each suitable communication technology may be used. The respective components, each may include one or more communications interface for communicating with each other. Such communication may be executed using a wired data transmission protocol, such as fiber distributed data interface (FDDI), digital subscriber line (DSL), Ethernet, asynchronous transfer mode (ATM), or any other wired transmission protocol. Alternatively, the communication may be wirelessly via wireless communication networks using any of a variety of protocols, such as General Packet Radio Service (GPRS), Universal Mobile Telecommunications System (UMTS), Code Division Multiple Access (CDMA), Long Term Evolution (LTE), wireless Universal Serial Bus (USB), and/or any other wireless protocol. The respective communication may be a combination of a wireless and a wired communication.

In still a further aspect, embodiments of the invention are directed to a computer program product having instructions that are executable by one or more data processing units as described before, the instructions cause a machine to:
provide at least one object to be recognized, the object being at least semi-transparent and having object specific transmission and luminescence spectral patterns,
illuminate, using a light source, a scene including the at least one object under ambient lighting conditions,
provide two linear polarizers which are aligned at an angle in the range of −5 to 5 degrees, preferably of −3 to 2 degrees, more preferably of −1 to 1 degrees relative to each other or rotated at an angle in the range of 85 to 95 degrees, particularly of 87 to 92 degrees, more preferably of 89 to 91 degrees to each other, and which are sandwiching the at least one object between them,
measure, using a sensor, radiance data of the scene including the at least one object,
provide a data storage unit which comprises luminescence spectral patterns together with appropriately assigned respective objects,
detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

In still a further embodiment, the present disclosure refers to a non-transitory computer-readable medium storing instructions that, when executed by one or more processors, particularly by one or more data processing units as described before, cause a machine to:
provide at least one object to be recognized, the object being at least semi-transparent and having object specific transmission and luminescence spectral patterns,
illuminate, using a light source, a scene which includes the at least one object under ambient lighting conditions,
provide two linear polarizers which are aligned at an angle in the range of −5 to 5 degrees, preferably of −3 to 2 degrees, more preferably of −1 to 1 degrees relative to each other or rotated at an angle in the range of 85 to 95 degrees, particularly of 87 to 92 degrees, more preferably of 89 to 91 degrees to each other, and which are sandwiching the at least one object between them,
measure, using a sensor, radiance data of the scene including the at least one object,
provide a data storage unit which comprises luminescence spectral patterns together with appropriately assigned respective objects,
detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

In still another embodiment, the present disclosure refers to a non-transitory computer-readable medium storing instructions that when executed by one or more processors, cause a machine to:
provide at least one object to be recognized, the object having object specific reflectance and luminescence spectral patterns,
illuminate a scene which includes the at least one object under ambient lighting conditions using a light source,
provide a linear polarizer coupled with a quarter waveplate, the quarter waveplate being oriented with its fast and slow axes at an angle in the range of 40 to 50 degrees, preferably of 42 to 48 degrees, more preferably of 44 to 46 degrees relative to the linear polarizer, and
position the linear polarizer and the quarter waveplate between a sensor and the at least one object, and between the light source and the at least one object,
measure, using the sensor, radiance data of the scene including the at least one object,
provide a data storage unit which comprises luminescence spectral patterns together with appropriately assigned respective objects,
detect the object specific luminescence spectral pattern of the at least one object to be recognized out of the measured radiance data of the scene,
match the detected object specific luminescence spectral pattern with the luminescence spectral patterns stored in the data storage unit, and
identify a best matching luminescence spectral pattern and, thus, its assigned object.

The invention is further defined in the following examples. It should be understood that these examples, by indicating preferred embodiments of the invention, are given by way of illustration only. From the above discussion and the examples, one skilled in the art can ascertain the essential characteristics of this invention and without departing from the spirit and scope thereof, can make various changes and modifications of the invention to adapt it to various uses and conditions.

### BRIEF DESCRIPTION OF THE DRAWINGS

FIG. 1 shows schematically a section of a first embodiment of the system according to the present disclosure.

FIG. 2 shows schematically a section of a second embodiment of the system according to the present disclosure.

FIG. 3 shows schematically a section of a third embodiment of the system according to the present disclosure.

FIG. 4 shows a diagram of measured radiance and emission data which have been received using an embodiment of the system according to the present disclosure.

### DETAILED DESCRIPTION OF THE DRAWINGS

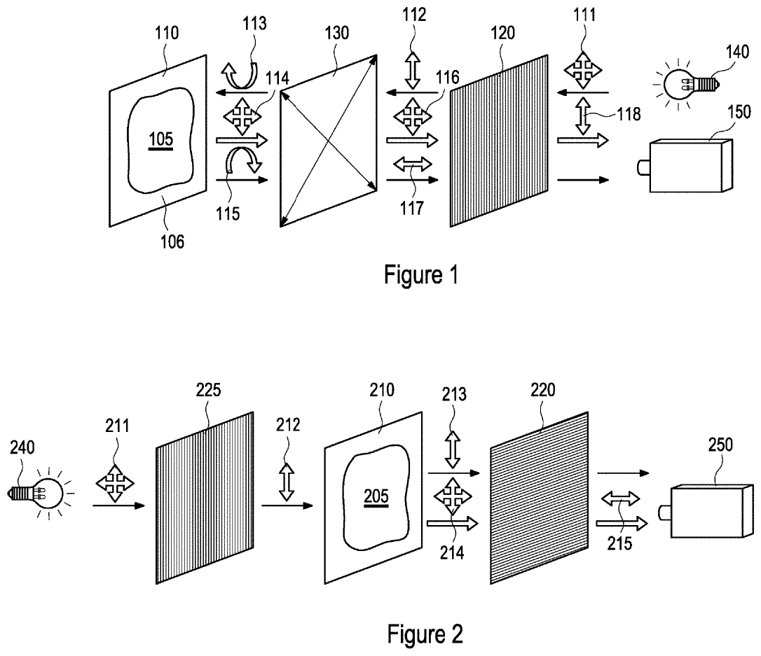

FIG. 1 shows a first embodiment of a system according to the present invention. The system comprises an object 110 which is to be recognized and which is provided/imparted with a fluorescent material as indicated by reference sign 105. Further, the object 110 has also a specular reflective surface 106. The system further comprises a linear polarizer 120 and a quarter waveplate 130. Furthermore, the system comprises a light source 140 which is configured to illuminate a scene including the object 110. Between the light source 140 and the object 110 and between the object 110 and a sensor 150 the linear polarizer 120 and the quarter waveplate 130 are arranged. The linear polarizer 120 can be in any position. The quarter waveplate 130 must have its fast and slow axes as indicated by the respective double arrows at about 45 degrees (ideally, small deviations are acceptable) to the linear polarizer orientation, but otherwise the orientation of the quarter waveplate 130 does not matter. For example, the fast and slow axes can be switched relative to the linear polarizer 120. Further, it is possible that the linear polarizer 120 and the quarter waveplate 130 are fused together and can be applied directly on top of the object 110 to give a 3-layer construct. The system further comprises the sensor 150 which is configured to sense the light coming back from the object 110 after having passed the quarter waveplate 130 and the linear polarizer 120. The sensor 150 is coupled with a data processing unit which is not shown here and a data storage unit which stores a database with a plurality of fluorescence spectral patterns of a respective plurality of different objects. In operation, the light source 140 emits unpolarised light onto the linear polarizer 120. The linear polarizer 120 linearly polarizes the incoming light 111, then the quarter waveplate 130 converts the linearly polarized light 112 to circularly polarized light 113. Upon reflection from the object 110, the circular polarization of the light 113 is converted by reflection at the reflective surface 106 to the opposite phase 115. A part of the light, namely the light of that wavelength which is needed to excite the fluorescent material 105 which is imparted on the object 110 is partially absorbed and emitted at a longer wavelength. The fluoresced light 114 is largely devoid of polarization. When passing through the quarter waveplate 130 the unpolarised light 114 can pass the quarter waveplate 130 without being disturbed 116 and about half of it can also escape the linear polarizer 120 as linearly polarized light 118. This light 118 can then be observed and measured by the sensor 150. In contrast thereto, the light 115 is transformed once again by the quarter waveplate 130 to linearly polarized light 117. This linearly polarized light 117 is of wrong phase to pass back through the linear polarizer 120 and, thus, reflection at the object 110 is suppressed or at least reduced. As the fluorescence emission only changes in magnitude with changes in excitation light, the fluorescence spectrum of the measured emitted light 118 is still indicative of the object 110 which is to be recognized and can, therefore, be used for object identification. The entire construct as shown in FIG. 1 can be applied to a portion of the object to be recognized or as a coating or wrap over the majority or entirety of the object 110. Preferably, it is possible with one multi- or hyperspectral image of the object 110 to acquire information for identifying the object 110 from the observable fluorescence spectrum of the measured emitted light 118.

FIG. 2 shows a section of an alternative embodiment of the proposed system. The system shown in FIG. 2 comprises a light source 240, an object 210 which is to be recognized and a sensor 250. The object 210 is imparted with a fluorescence material 205 so that the object 210 can be identified by means of its object-specific fluorescence spectral pattern. Further, the object 210 is highly transparent so that light hitting the object 210 can pass through the object 210. The system further comprises two linear polarizers 220 and 225. The linear polarizers 220 and 225 can be in any orientation but must be at about 90 degrees relative to each other, i. e. at an angle in the range of 85 to 95 degrees, preferably of 87 to 92 degrees, more preferably of 89 to 91 degrees relative to each other. In the embodiment shown here, the object 210 which is imparted/provided with the fluorescent material, is sandwiched between the two linear polarizers 220 and 225. It is possible that the linear polarizers 220 and 225 are applied directly on either side of the fluorescent material 205 of the object 210. The object 210 and the fluorescent material 205 provided on the object 210 must have a degree of transparency so that light can be transmitted through the fluorescent material 205 and the object 210 to the other side.

When operating, the light source 240 emits unpolarised light 211 which hits the linear polarizer 225 which first linearly polarizes the incoming light 211. The polarized light 212 then hits the object 210. A part 213 of the polarized light only passes the object 210 without any disturbance. The linearly polarized light 212 reaching the fluorescent material 205 that is of the correct energy to excite the fluorescent material 205 is partially absorbed and emitted at a longer wavelength. The fluoresced light 214 is largely devoid of polarization, so that only about half of it cannot pass through the second linear polarizer 220. The light 213 which is not absorbed but passed through the object 210 without any disturbance cannot pass the second linear polarizer 220 due to its orientation at about 90 degree relative to the second linear polarizer 225. Therefore, the light 215 which can be observed and measured by the sensor 250 only results from the fluoresced light 214 which can pass the second linear polarizer 220 and leaves the second linear polarizer 220 as polarized light 215. This measured light 215 is indicative of the fluorescence material 205 of the object 210 and can, therefore, be used for object identification. For that purpose, the sensor 250 is in communicative contact with a data storage unit with a database storing different objects with different fluorescence spectral patterns and a data processing unit which is configured to match the measured fluorescence spectral pattern of the object 210 to a fluorescence spectral pattern stored in the database. Both, the database and the data processing unit are not shown here.

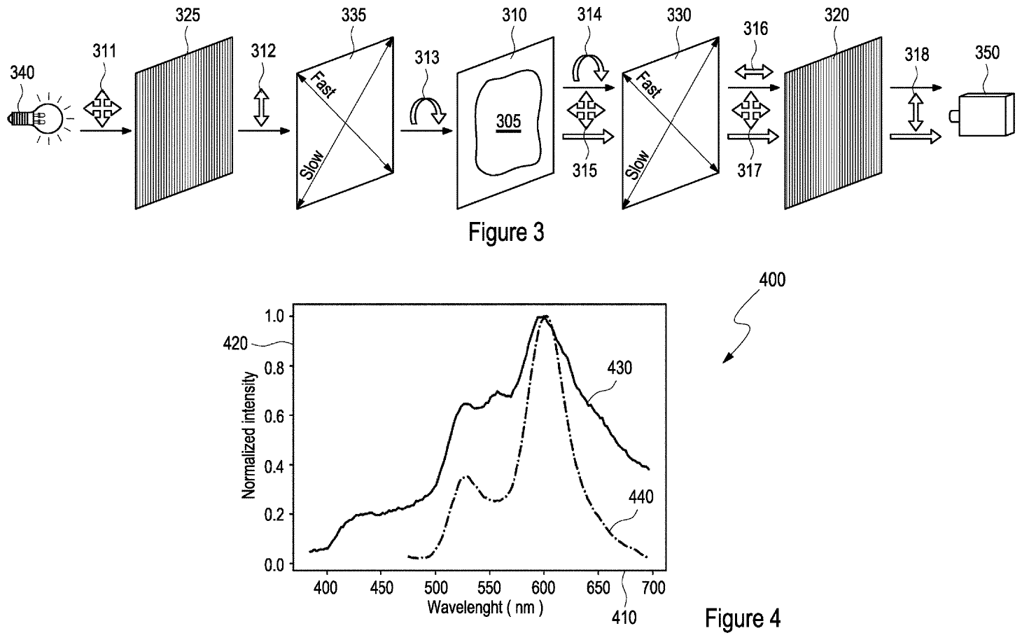

FIG. 3 shows a section of still a further embodiment of the proposed system. The system comprises a light source 340, an object 310 which is to be recognized and a sensor 350. The system further comprises a data processing unit and a database, both are not shown here, but are in communicative connection with at least the sensor 350. The object 310 which is to be recognized is again formed of a transparent material and further provided with a fluorescent material 305 with a specific fluorescence spectral pattern. The system further comprises two linear polarizers 320 and 325 and two quarter waveplates 330 and 335. Each quarter waveplate is assigned to a respective linear polarizer. Thus, the quarter waveplate 330 is assigned to the linear polarizer 320 and the quarter waveplate 335 is assigned to the linear polarizer 325. As already described with respect to FIG. 1, the linear polarizers 320, 325 can be in any orientation and also in any position. If the linear polarizers 320, 325 are aligned at about 0 degrees relative to each other, as shown in FIG. 3, then the quarter waveplate which is assigned to the respective linear polarizer must have its fast and slow axes at about 45 degrees relative to the linear polarizer orientation and at about 0 degrees relative to the other quarter waveplate. That means that the quarter waveplate 330 must be oriented at about 45 degrees relative to the linear polarizer 320. The quarter waveplate 335 must be oriented at about 45 degrees relative to the linear polarizer 325. In the arrangement shown in FIG. 3, the object 310 is sandwiched by the two linear polarizers 320, 325 and the two quarter waveplates 330, 335. On both sides of the object 310 a pair formed by a linear polarizer and a quarter waveplate is arranged. It is possible that in that sequence, the linear polarizers and the quarter waveplates are fused together and are applied directly on top of either side of the fluorescent material 305 of the object 310 to give a 5-layer construct with each layer directly on top of the other.

When operating, the light source 340 emits unpolarised light 311 which hits the linear polarizer 325. The linear polarizer 325 first linearly polarizes the incoming light 311 into polarized light 312. When the polarized light 312 hits the quarter waveplate 335, the quarter waveplate 335 converts the linearly polarized light 312 to circularly polarized light 313. A part of the circularly polarized light 313 can then pass throught the object 310 without any disturbance and exits the object 310 as circularly polarized light 314. The circularly polarized light reaching the fluorescent material 305 of the object 310 that is of the correct energy to excite the fluorescent material 305 is partially absorbed and emitted at a longer wavelength. The fluoresced light 315 is largely devoid of polarization so there is no net change upon passing through the quarter waveplate 330 as still unpolarised light 317. About half of the unpolarised light 317 is absorbed by the second linear polarizer 320, and the remained is passed as a linear polarised light 318. The circularly polarized 314 which hits the quarter waveplate 330 is converted to linearly polarised light 316. This linearly polarized light 316 is, however, of the wrong phase to pass back through the linear polarizer 320, and thus no light which has not been fluoresced by the object 310 can exit the linear polarizer 320. Thus, only the light 315 which has been fluoresced by the object 310 can exit the linear polarizer 320. The spectrum of the measured emitted light 318 is indicative of the fluorescence material of the object 310 and can be used for object identification by matching the measured fluorescence spectral pattern with the database.

Various configurations, i.e. polarizer and quarter waveplate orientations relative to each other, are possible for this design. All constructs rely on the principle of linearly polarizing the incoming light, optionally circularly polarizing the light, allowing the light to hit the fluorescent material of the object to be recognized and, thus, stimulate the emission of non-polarized light, converting the circularly polarized light to linearly polarized light if necessary and filtering out the remaining incoming light with an appropriate linear polarizer. Approximately, half of the emitted light, however, is able to escape the final linear polarizer and can be perceived or measured by a respective sensor. Due to optical losses, at most 50% of the emitted light can escape the final linear polarizer.

FIG. 4 shows a diagram 400 with a horizontal axis 410 and a vertical axis 420. Along the horizontal axis 410 the wavelength of light is plotted in nanometer. On the vertical axis 420 a normalized intensity of the light is plotted. The curve 430 indicates measured radiance using a hyperspectral camera and the curve 440 indicates measured emission of a light source using a fluorometer.

### LIST OF REFERENCE SIGNS

105 fluorescent material
106 reflective surface
110 object
111 incoming light
112 linearly polarized light
113 circularly polarized light
114 unpolarized light
115 circularly polarized light
116 unpolarized light
117 linearly polarized light
118 linearly polarized light
120 linear polarizer
130 quarter waveplate
140 light source
150 sensor
205 fluorescent material
210 object
211 incoming light
212 linearly polarized light
213 linearly polarized light
214 unpolarized light
215 linearly polarized light
220, 225 linear polarizer
240 light source
250 sensor
305 fluorescent material
310 object
311 incoming light
312 linearly polarized light
313 circularly polarized light
314 circularly polarized light
315 unpolarized light
316 linearly polarized light
317 unpolarized light
318 linearly polarized light
320, 325 linear polarizer
330, 335 quarter waveplate
340 light source
350 sensor

1. A system for object recognition via a computer vision application, the system comprising at least the following components:
at least one object to be recognized, the object having object specific reflectance and luminescence spectral patterns,
a light source which is configured to illuminate a scene including the at least one object under ambient lighting conditions,
a sensor which is configured to measure radiance data of the scene including the at least one object when the scene is illuminated by the light source,
a linear polarizer coupled with a quarter waveplate, the quarter waveplate being oriented with its fast and slow axes at an angle in the range of 40 to 50 degrees relative to the linear polarizer, the linear polarizer and the quarter waveplate being positioned between the sensor and the at least one object, and between the light source and the at least one object,
a data storage unit which comprises luminescence spectral patterns together with appropriately assigned respective objects, and
a data processing unit which is configured to detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

2. The system according to claim 1, wherein the linear polarizer and the quarter waveplate are fused together forming one optical component.

3. The system according to claim 2, wherein the linear polarizer and the quarter waveplate are applied directly on top of the at least one object to form a 3-layer construct.

4. A system for object recognition via a computer vision application, the system comprising at least the following components:
at least one object to be recognized, the object being at least semi-transparent and having object specific transmission and luminescence spectral patterns,
a light source which is configured to illuminate a scene including the at least one object under ambient lighting conditions,
two linear polarizers which are aligned at an angle in the range of −5 to 5 degrees relative to each other or rotated at an angle in the range of 85 to 95 degrees to each other and which are sandwiching the at least one object between them,
a sensor which is configured to measure radiance data of the scene including the at least one object when the scene is illuminated by the light source,
a data storage unit which comprises luminescence spectral patterns together with appropriately assigned respective objects, and
a data processing unit which is configured to detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

5. The system according to claim 4, wherein the linear polarizers are applied directly on either side of the at least one object.

6. The system according to claim 4 wherein each of the two linear polarizers is coupled with a quarter waveplate, wherein the linear polarizers are aligned at an angle in the range of −5 to 5 degrees relative to each other and each of the quarter waveplate being oriented with its fast and slow axes at an angle in the range of 40 to 50 degrees relative to the respective linear polarizer and each quarter waveplate being oriented at about 0 degrees relative to the other quarter waveplate.

7. The system according to claim 6, wherein the two linear polarizers and the respective two quarter waveplates each coupled with one of the two linear polarizers are applied directly on either side of the at least one object, thus forming a 5-layer construct with each layer directly on top of the other.

8. The system according to claim 1, wherein the sensor is a hyperspectral camera or a multispectral camera.

9. A method for object recognition via a computer vision application, the method comprising at least the following steps:
providing at least one object to be recognized, the object having object specific reflectance and luminescence spectral patterns,
illuminating a scene including the at least one object under ambient lighting conditions using a light source,
providing a linear polarizer coupled with a quarter waveplate, the quarter waveplate being oriented with its fast and slow axes at an angle in the range of 40 to 50 degrees relative to the linear polarizer, and
positioning the linear polarizer and the quarter waveplate between a sensor and the at least one object, and between the light source and the at least one object,
measuring, using the sensor, radiance data of the scene including the at least one object,
providing a data storage unit which comprises luminescence spectral patterns together with appropriately assigned respective objects,
detecting the object specific luminescence spectral pattern of the at least one object to be recognized out of the measured radiance data of the scene,
matching the detected object specific luminescence spectral pattern with the luminescence spectral patterns stored in the data storage unit, and
identifying a best matching luminescence spectral pattern and, thus, its assigned object.

10. The method according to claim 9, wherein the linear polarizer and the quarter waveplate are applied directly on top of the at least one object to form a 3-layer construct.

11. A method for object recognition via a computer vision application, the method comprising at least the following steps:
providing at least one object to be recognized, the object being at least semi-transparent and having object specific transmission and luminescence spectral patterns,
illuminating, using a light source, a scene including the at least one object under ambient lighting conditions,
providing two linear polarizers which are aligned at an angle in the range of −5 to 5 degrees relative to each other or rotated at an angle in the range of 85 to 95 degrees to each other and which are sandwiching the at least one object between them,
measuring, using a sensor, radiance data of the scene including the at least one object,
providing a data storage unit which comprises luminescence spectral patterns together with appropriately assigned respective objects, and
providing a data processing unit which is programmed to detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

12. The method according to claim 11, wherein the linear polarizers are applied directly on either side of the at least one object.

13. The method according to claim 11 wherein each of the two linear polarizers is coupled with a quarter waveplate, wherein the linear polarizers are aligned at an angle in the range of −5 to 5 degrees relative to each other and each of the quarter waveplate being oriented with its fast and slow axes at an angle in the range of 40 to 50 degrees relative to the respective linear polarizer and each quarter waveplate being oriented at about 0 degrees relative to the other quarter waveplate.

14. The method according to claim 11 wherein the two linear polarizers and the respective two quarter waveplates each coupled with one of the two linear polarizers are applied directly on either side of the at least one object, thus forming a 5-layer construct with each layer directly on top of the other.

15. A non-transitory computer-readable medium storing instructions that when executed by one or more processors, cause a machine to:
provide at least one object to be recognized, the object being at least semi-transparent and having object specific transmission and luminescence spectral patterns,
illuminate, using a light source, a scene including the at least one object under ambient lighting conditions,
provide two linear polarizers which are aligned at an angle in the range of −5 to 5 degrees relative to each other or rotated at an angle in the range of 85 to 95 degrees, to each other, and which are sandwiching the at least one object between them,
measure, using a sensor, radiance data of the scene including the at least one object,
provide a data storage unit which comprises luminescence spectral patterns together with appropriately assigned respective objects, and
detect the object specific luminescence spectral pattern of the at least one object to be recognized out of the measured radiance data of the scene and to match the detected object specific luminescence spectral pattern with the luminescence spectral patterns stored in the data storage unit, and to identify a best matching luminescence spectral pattern and, thus, its assigned object.

16. The system according to claim 1, wherein the quarter waveplate is oriented with its fast and slow axes at an angle in the range of 42 to 48 degrees relative to the linear polarizer.

17. The system according to claim 4, wherein the two linear polarizers are aligned at an angle in the range of −3 to 2 degrees relative to each other.

18. The system according to claim 4, wherein the two linear polarizers are rotated at an angle in the range of 87 to 92 degrees to each other.

19. The method according to claim 9, wherein the quarter waveplate is oriented with its fast and slow axes at an angle in the range of 42 to 48 degrees relative to the linear polarizer.

20. The method according to claim 11, wherein the two linear polarizers are aligned at an angle in the range of −3 to 2 degrees relative to each other.
